(19) United States
(12) Patent Application Publication
(10) Pub. No.: US 2011/0303047 A1
(43) Pub. Date: Dec. 15, 2011

(54) VEHICLE TRANSMISSION HAVING DIFFERENTIAL FUNCTION

(76) Inventor: Jiunn-Ruey WANG, Taichung City (TW)

(21) Appl. No.: 12/797,295

(22) Filed: Jun. 9, 2010

(51) Int. Cl. F16H 48/12

(52) U.S. Cl. 74/650

(57) ABSTRACT

A vehicle transmission includes two aligned axles, a sleeve assembly adapted to be driven by a power source to rotate about a central axis thereof, and two ratchet mechanisms disposed respectively at two opposite axial ends of the sleeve assembly. The ratchet mechanisms are connected respectively to the axles in such a manner to allow for transfer of rotation from the sleeve assembly to the axles via the ratchet mechanisms when the sleeve assembly is rotated in a positive direction, while preventing transfer of rotation from the axles to the sleeve assembly via the ratchet mechanisms, thereby permitting the axles to rotate at different speeds.

### BACKGROUND OF THE INVENTION

1. Field of the Invention

This invention relates to a vehicle transmission, and more particularly to a vehicle transmission that has differential function and that can drive two wheels in such a manner to allow the wheels to rotate at different speeds.

2. Description of the Related Art

A differential has been used in a vehicle transmission to allow aligned left and right wheels to rotate at different speeds during a turn of the vehicle. A conventional differential, however, typically includes a plurality of bevel gears. Thus, the conventional differential is complex in structure, high in the manufacturing cost, and difficult to maintain and repair.

### SUMMARY OF THE INVENTION

The object of this invention is to provide a vehicle transmission with an improved differential that has a simple structure.

Accordingly, a vehicle transmission of this invention includes two aligned axles, a sleeve assembly adapted to be driven by a power source to rotate about a central axis thereof, and two ratchet mechanisms disposed respectively at two opposite axial ends of the sleeve assembly. The ratchet mechanisms are connected respectively to the axles in such a manner to allow for transfer of rotation from the sleeve assembly to the axles via the ratchet mechanisms when the sleeve assembly is rotated in a positive direction, while preventing transfer of rotation from the axles to the sleeve assembly via the ratchet mechanisms, thereby permitting the axles to rotate at different speeds.

Since a differential is constituted by only the ratchet mechanisms and the sleeve assembly, the transmission is simple in structure.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a front view of the preferred embodiment of a vehicle transmission according to this invention and two wheels when a clutch is at a disengagement position;

FIG. 2 is a fragmentary exploded perspective view of the preferred embodiment;

FIG. 3 is an assembled perspective view of the preferred embodiment;

FIG. 4 is a sectional view of the preferred embodiment;

FIG. 5 is a sectional view taken along line V-V in FIG. 4;

FIG. 6 is a sectional view of the preferred embodiment when the clutch is at an engagement position; and

FIG. 7 is a sectional view taken along line VII-VII in FIG. 6.

### DETAILED DESCRIPTION OF THE PREFERRED EMBODIMENT

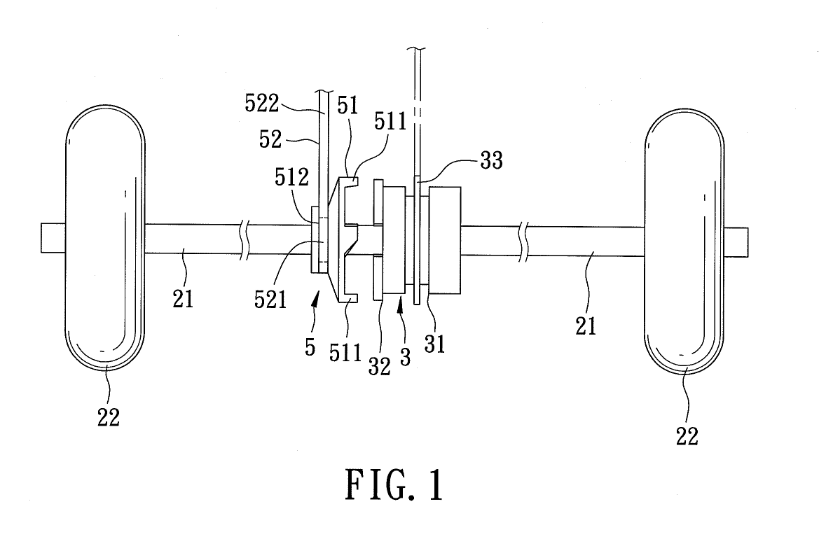

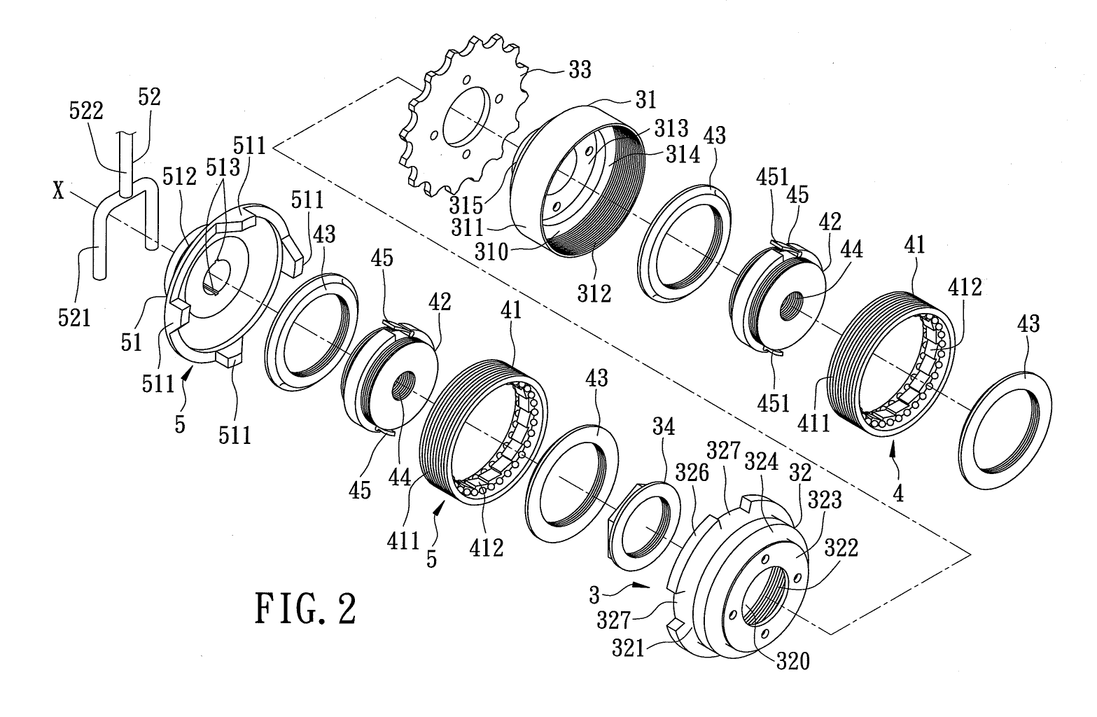

Referring to FIG. 1, the preferred embodiment of a vehicle transmission according to this invention is adapted for driving two aligned wheels 22. With further reference to FIGS. 2, 3, and 4, the vehicle transmission includes two axles 21, a sleeve assembly 3, two ratchet mechanisms 4, and a reversing unit 5. The axles 21 are connected respectively and co-rotatably to the wheels 22.

The sleeve assembly 3 includes a three-stepped first sleeve 31, a two-stepped second sleeve 32 coaxial with the first sleeve 31, a driven member 33, and a lock nut 34. The first sleeve 31 has an annular surrounding wall 311 rotatable about a central axis (X) and defining a cylindrical receiving space 310 for receiving the corresponding ratchet mechanism 4. The surrounding wall 311 has an internally threaded portion 312. The first sleeve 31 further has a small annular plate portion 313 perpendicular to the central axis (X), a large annular plate portion 314 extending radially and inwardly from an end of the surrounding wall 311, and an externally threaded section 315 extending axially from an inner periphery of the small annular plate portion 313. The second sleeve 32 has an annular surrounding wall 321 rotatable about the central axis (X) and defining a cylindrical receiving space 320 for receiving the corresponding ratchet mechanism 4. The surrounding wall 321 has an internally threaded portion 322. The second sleeve 32 further has a small annular plate portion 323 disposed at an end thereof, a large annular plate portion 324 extending radially and inwardly from an end of the surrounding wall 321, and a plurality of angularly equidistant ribs 326 extending radially and outwardly from an opposite end thereof. Each adjacent pair of the ribs 326 defines a notch 327 therebetween. As such, the notches 327 are circumferentially spaced apart from each other. The driven member 33 is sleeved fixedly on the externally threaded section 315 of the first sleeve 31 and disposed between the small annular plate portions 313, 323 of the first and second sleeves 31, 32. It should be noted that, the driven member 33 is adapted to be connected to a power source (not shown) for transmitting power from the same. In this embodiment, the driven member 33 is configured as a spur gear. Alternatively, the driven member 33 may be a belt pulley or a gearing. The externally threaded section 315 of the first sleeve 31 extends through the second sleeve 32, and engages the nut 34 to clamp the driven member 33 between the first and second sleeves 31, 32 to thereby allow for co-rotation of the driven member 33 with the first and second sleeves 31, 32.

The ratchet mechanisms 4 are disposed respectively within the receiving spaces 310, 320 in the first and second sleeves 31, 32, and abut respectively against the large annular plate portions 314, 324. Each of the ratchet mechanisms 4 includes an outer ring 41, an inner ring 42 disposed coaxially within the outer ring 41 and having a threaded hole 44, two internally threaded locking members 43 sleeved respectively on and threaded respectively to two opposite ends of the inner ring 42 in such a manner to allow for rotation of the outer ring 41 relative to the inner ring 42, while preventing movement of the outer ring 41 relative to the inner ring 42, and two diametrically opposed pawls 45 attached to an outer surface of the inner ring 42. Each of the outer rings 41 has an externally threaded portion 411 engaging the internally threaded portion 312, 322 of a corresponding one of the first and second sleeves 31, 32 for co-rotation with the same, and a ratchet surface 412. The threaded hole 44 of each of the inner rings 42 engages an externally threaded portion of the corresponding axle 21, such that the inner rings 42 are sleeved respectively and fixedly on the axles 31. The pawls 45 engage respectively the ratchet surfaces 412 of the outer rings 41. As such, the sleeve assembly 3 can be driven by the power source to rotate about the central axis (X) so as to allow for transfer of rotation from the sleeve assembly 3 to the axles 21 via the ratchet mechanisms 4 when the sleeve assembly 3 is rotated in a positive direction, while preventing transfer of rotation from the axles 21 to the sleeve assembly 3 via the ratchet mechanisms 4, thereby permitting the axles 21 to rotate at different speeds.

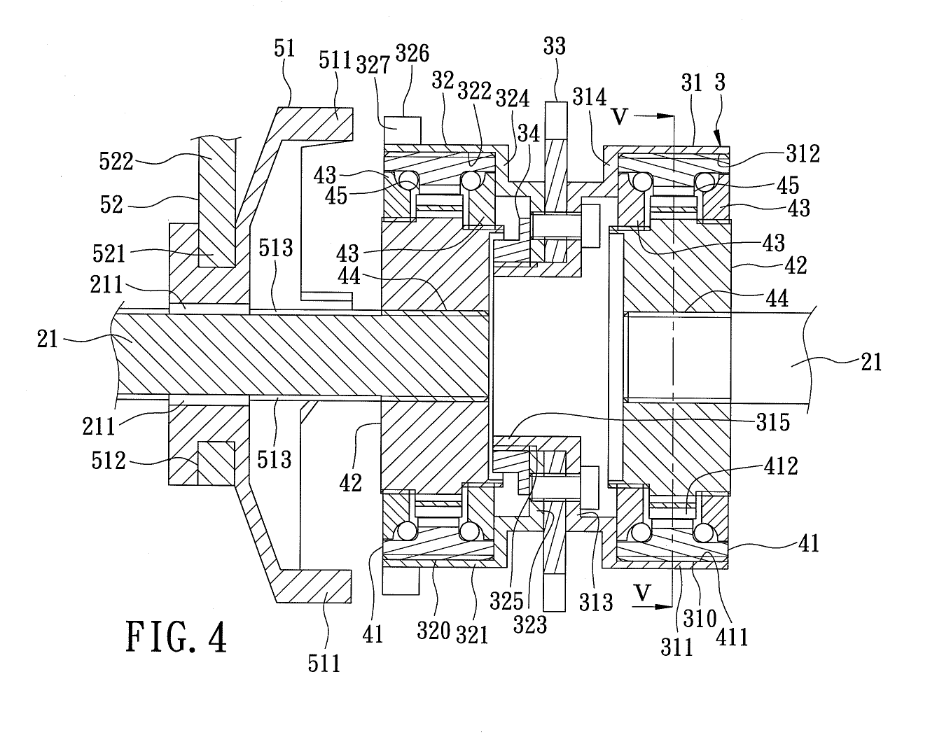

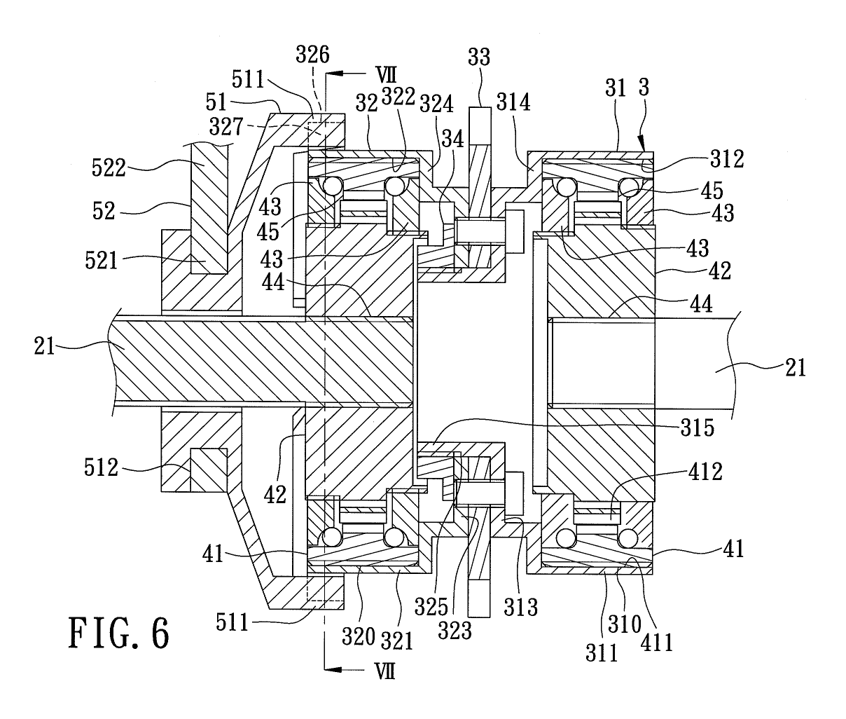

The reversing unit 5 includes a clutch 51 and a controlling member 52. One of the axles 21 is formed with two diametrically opposed keyways 211. The clutch 51 has an inner surface that is formed with two axially extending keys 513 engaging respectively and movably the keyways 211 in the one of the axles 21, such that the clutch 51 is movable axially relative to the one of the axles 21. The clutch 51 has a plurality of axially extending engagement teeth 511 movable to engage respectively the notches 327 in the second sleeve 32, and an outer surface formed with an annular groove 512. The controlling member 52 has an inverted U-shaped clamping portion 521 inserted into the annular groove 512 in the clutch 51 and straddling the clutch 51, and a pushing portion 522 disposed above and connected integrally to the clamping portion 521. Through operation of the controlling member 52, the clutch 52 is movable axially on the one of the axles 21 between a disengagement position shown in FIG. 4, where the clutch 52 is spaced apart from the second sleeve 32, and an engagement position shown in FIG. 6, where the engagement teeth 511 of the clutch 52 engage the notches 327 of the second sleeve 32 to allow for transfer of rotation of the sleeve assembly 3 in a reverse direction opposite to the positive direction to the one of the axles 21 via the reversing unit 5.

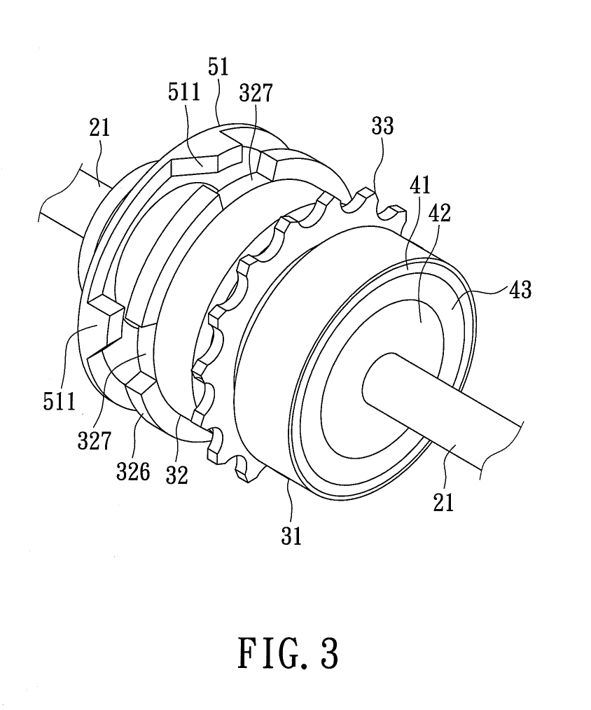

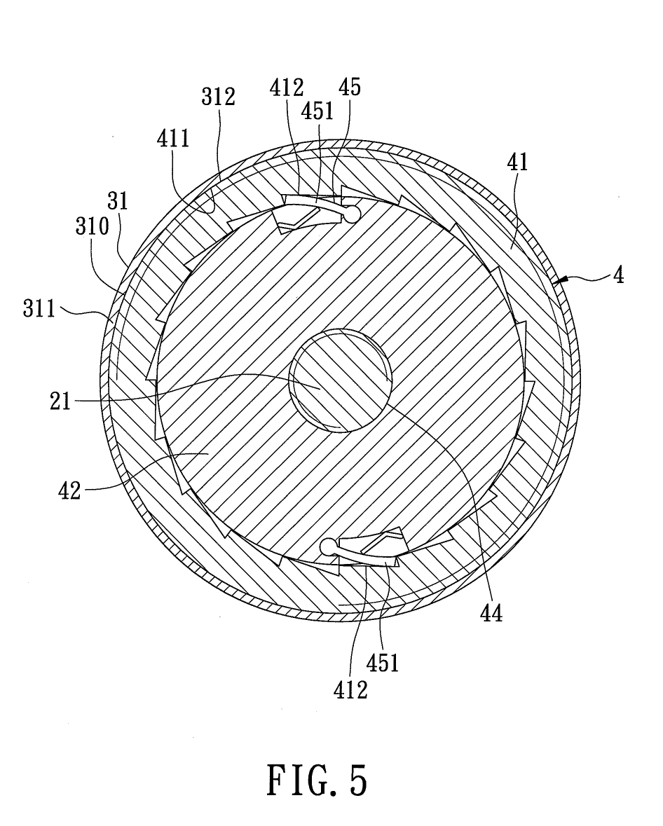

With particular reference to FIGS. 3, 4, and 5, when forward movement of the vehicle is desired, the controlling member 52 is first operated to move the clutch 51 to the disengagement position. Next, the power source is operated manually or electrically to drive rotation of the driven member 33 and, thus, the first and second sleeves 31, 32 about the central axis (X) in the positive direction. At this time, since rotation of the sleeve assembly 3 is in the positive direction, it can be transferred to the axles 21 via the ratchet mechanisms 4 to thereby drive the vehicle to move forwardly, such that the wheels 22 rotate in the positive direction at the same speed.

During advancement of the vehicle and when the vehicle is turned to the left, due to the presence of the ratchet mechanisms 4, the right wheel 22 rotates at a speed faster than those of the left wheel 22 and the sleeve assembly 3. As a result, rotation of the axles 21 at different speeds is allowed.

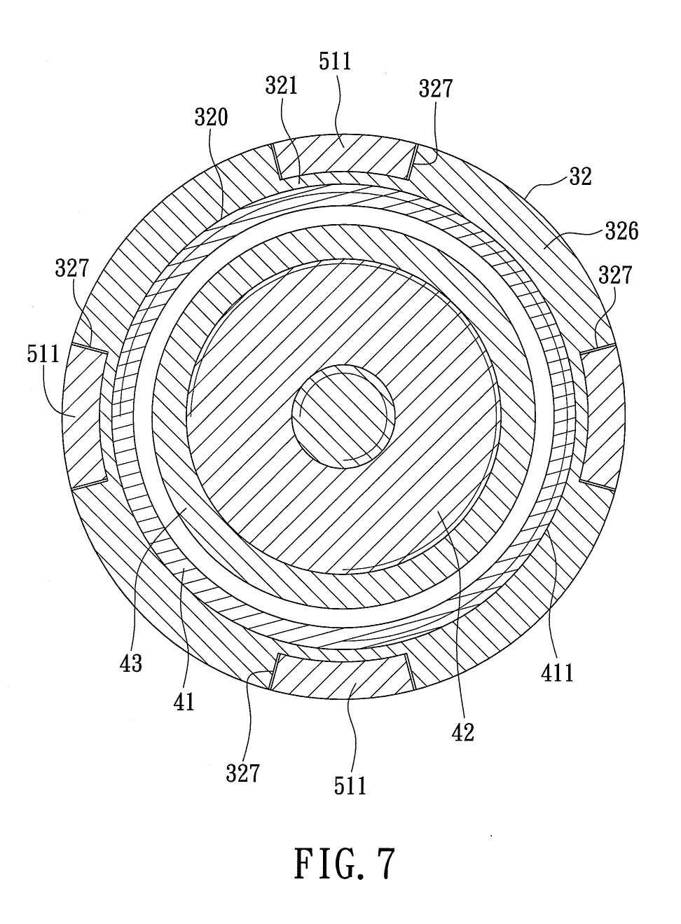

With particular reference to FIGS. 6 and 7, when backward movement of the vehicle is desired, the controlling member 52 is operated to move the clutch 51 to the engagement position. Subsequently, the power source is operated to drive the driven member 33 and, thus, the first and second sleeves 31, 32 to rotate in the reverse direction. As a result, rotation of the sleeve assembly 3 in the reverse direction is transferred to the one of the axles 21 via the reversing unit 5.

In view of the above, the vehicle transmission of this invention has the following advantages:
1. Since a differential is constituted by only the ratchet mechanisms 4 and the sleeve assembly 3, the structure of the vehicle transmission is relatively simple, and the applicable range of the vehicle transmission is increased. For example, the vehicle transmission of this invention can be used for a tricycle, a four-wheel vehicle, a model vehicle, etc.
2. The vehicle transmission is comprised of a small number of components, which leads to a decrease in the manufacturing cost, the power consumption, and the space occupied thereby. Furthermore, the vehicle transmission is easy to maintain and repair.
3. Through the design of the reversing unit 5, forward and backward movement of the vehicle is allowed.

With this invention thus explained, it is apparent that numerous modifications and variations can be made without departing from the scope and spirit of this invention. It is therefore intended that this invention be limited only as indicated by the appended claims.

I claim:

1. A vehicle transmission comprising:
two aligned axles;
a sleeve assembly adapted to be driven by a power source to rotate about a central axis thereof; and
two ratchet mechanisms disposed respectively at two opposite axial ends of said sleeve assembly and connected respectively to said axles in such a manner to allow for transfer of rotation from said sleeve assembly to said axles via said ratchet mechanisms when said sleeve assembly is rotated in a positive direction, while preventing transfer of rotation from said axles to said sleeve assembly via said ratchet mechanisms, thereby permitting said axles to rotate at different speeds.

2. The vehicle transmission as claimed in claim 1, wherein said sleeve assembly includes first and second sleeves connected co-rotatably to each other and connected respectively to said ratchet mechanisms.

3. The vehicle transmission as claimed in claim 2, wherein said sleeve assembly further includes a driven member disposed fixedly between said first and second sleeves and adapted to be connected to the power source.

4. The vehicle transmission as claimed in claim 3, wherein said sleeve assembly further includes a lock nut, said first sleeve having an externally threaded section extending through said second sleeve and engaging said lock nut to clamp said driven member between said first and second sleeves in such a manner to allow for co-rotation of said driven member with said first and second sleeves.

5. The vehicle transmission as claimed in claim 3, wherein said driven member is configured as a spur gear.

6. The vehicle transmission as claimed in claim 2, wherein each of said first and second sleeves has an annular surrounding wall rotatable about the central axis and defining a receiving space for receiving a corresponding one of said ratchet mechanisms.

7. The vehicle transmission as claimed in claim 6, wherein said surrounding wall of each of said first and second sleeves has an internally threaded portion, and each of said ratchet mechanisms includes an externally threaded portion engaging said internally threaded portion of said surrounding wall of a corresponding one of said first and second sleeves.

8. The vehicle transmission as claimed in claim 6, wherein each of said first and second sleeves has a large annular plate portion, said ratchet mechanisms abutting respectively against said large annular plate portions of said first and second sleeves.

9. The vehicle transmission as claimed in claim 1, wherein each of said ratchet mechanisms includes an outer ring co-rotatable with said sleeve assembly and having a ratchet surface, an inner ring disposed coaxially within said outer ring and sleeved fixedly on a corresponding one of said axles, and at least one pawl attached to an outer surface of said inner ring and engaging said ratchet surface of said outer ring.

10. The vehicle transmission as claimed in claim 1, further comprising a reversing unit, said reversing unit including a clutch and a controlling member, said clutch being disposed co-rotatably on one of said axles and being connected to said controlling member such that, through operation of said controlling member, said clutch is movable on the one of said axles between an engagement position whereat said clutch engages and is co-rotatable with said sleeve assembly, and a disengagement position whereat said clutch is removed from said sleeve assembly.

11. The vehicle transmission as claimed in claim 10, wherein said sleeve assembly further includes a plurality of circumferentially spaced-apart notches, and said clutch has a plurality of axially extending engagement teeth that engage respectively said notches when at the engagement position and that are removed respectively from said notches when at the disengagement position.

12. The vehicle transmission as claimed in claim 10, wherein said clutch has an outer surface formed with an annular groove, said controlling member having an inverted U-shaped clamping portion inserted into said annular groove and straddling said clutch, and a pushing portion disposed above and connected integrally to said clamping portion and operable to move said clutch between the engagement position and the disengagement position.
